(19) United States
(12) Patent Application Publication
(10) Pub. No.: US 2026/0347634 A1
(43) Pub. Date: Nov. 5, 2026

(54) NANOPARTICLE POPULATION, PRINTABLE COMPOSITION, AND METHOD FOR PRODUCING NANOPARTICLES

(71) Applicant: SHOEI CHEMICAL INC., Tokyo (JP)

(72) Inventors: Patrick Michael HABEN, Eugene, OR (US); Ercan BAYRAM, Corvallis, OR (US); Thomas NOVET, Corvallis, OR (US)

(21) Appl. No.: 19/099,447

(22) PCT Filed: Jul. 25, 2023
(86) PCT No.: PCT/JP2023/027234

§ 371 Date: Jan. 28, 2025

Related U.S. Application Data
(60) Provisional application No. 63/369,799, filed on Jul. 29, 2022.

(51) Int. Cl. C09D 11/52; C09D 11/322

(52) U.S. Cl. CPC C09D 11/52; C09D 11/322

(57) ABSTRACT

In one example of a nanoparticle population in accordance with one embodiment of the present invention, each nanoparticle of the nanoparticle population comprises a metal core and a metal oxide coating at least partially covering a surface of the metal core, wherein an average diameter of the nanoparticles of the nanoparticle population is within a range of 2 nm-200 nm, and wherein the metal oxide coating comprises one or more selected from the group consisting of Ba, Ti, Zr, Hf, V, Nb, Ta, W and Mo.

This present application claims the benefit of priority from U.S. Provisional Patent Application Ser. No. 63/369,799, filed on Jul. 29, 2022, and the entire content of which is incorporated herein by reference.

### TECHNICAL FIELD

This invention relates to nanoparticle populations, printable compositions, and methods for producing nanoparticles.

### BACKGROUND ART

Metal nanoparticles may be used in a variety of contexts. For example, multilayer ceramic capacitors (MLCC) may utilize electrodes formed from sintered metal nanoparticles. The electrodes of a MLCC are typically separated from one another by a metal oxide dielectric material with a relatively high dielectric constant, such as BaTiO₃.

### CITATION LIST

### Patent Literature

[Patent Document 1] Japanese unexamined patent publication No. H11-124602
[Patent Document 2] Japanese unexamined patent publication No. 2001-131602

### SUMMARY OF INVENTION

### Technical Problem

As mentioned above, metal nanoparticles may be used in a variety of contexts. One example is as a starting material for forming electrodes in an MLCC. MLCCs are widely used in modern electronic equipment. An MLCC may be fabricated by arranging alternating layers of a dielectric precursor composition and a metal precursor composition in a stack, and then sintering the stack. The metal precursor composition may comprise metal nanoparticles that are fused into a metal layer by the sintering process. Example metal nanoparticles that may be used for the fabrication of MLCC electrodes include palladium and nickel. Sintering temperatures may range from 1000 °C to 1400 °C for a MLCC, depending upon materials used in the MLCC.

Conventional MLCC electrodes may be formed using metal nanoparticles (e.g. nickel nanoparticles) having an average diameter, for example, within a range of 100-200 nm. In view of the constant drive for further miniaturization of electronic devices, there is an incentive to reduce MLCC sizes to help achieve the overall goal of smaller, more powerful electronic devices. The use of smaller metal nanoparticles may help to achieve further size reductions in MLCCs, as smaller metal nanoparticles may allow the formation of thinner electrodes in an MLCC.

However, manufacturing smaller metal nanoparticles may pose various difficulties. For example, at least two problems such as the following may be encountered in attempting to manufacture nickel nanoparticles with average diameters below approximately 80 nm (e.g. within a range of 30-80 nm).

First, current efforts to synthesize sub-80 nm nickel nanoparticles have focused on top-down methods that involve breaking apart larger nickel materials through mechanical (e.g. milling) or plasma methods. However, sub-80 nm nickel nanoparticles may be difficult to realize through such methods due to practical limitations. As such, “bottom-up” methods that nucleate and then grow nanoparticles from solution may provide a more feasible approach.

Second, nickel nanoparticles in the sub-80 nm size range may exhibit nanoscale properties, such as a reduced sintering temperature compared to bulk nickel. Whereas BaTiO₃ sinters at around 1100 °C, sub-80 nm nickel nanoparticles may sinter at temperatures as low as 250 °C. Sintering temperatures this far apart may lead to improper sintering (crack occurrence, etc.), which may impact MLCC integrity and reliability. Furthermore, it is also desirable for the nickel nanoparticle sintering temperature to be above the temperatures (often around 250 °C) used to thermally remove organic components (e.g. binder components) that may be present in metal precursor compositions and dielectric precursor compositions.

Therefore, the purpose of the present invention is to provide a nanoparticle population with a small average diameter and a high sintering temperature.

### Solution to Problem

The nanoparticle population in accordance with one embodiment of the present invention is a nanoparticle population, each nanoparticle of the nanoparticle population comprising:
a metal core; and
a metal oxide coating at least partially covering a surface of the metal core,
wherein an average diameter of the each nanoparticles is within a range of 2 nm-200 nm, and wherein the metal oxide coating comprises one or more selected from the group consisting of Ba, Ti, Zr, Hf, V, Nb, Ta, W and Mo.

The printable composition in accordance with one embodiment of the present invention comprises
a solvent and the nanoparticle population in accordance with one embodiment of the present invention dispersed in the solvent.

The method for synthesizing the nanoparticle in accordance with one embodiment of the present invention is
a method for synthesizing a nanoparticle comprising a metal core and a metal oxide coating at least partially covering a surface of the metal core, the method comprising:
obtaining a solution comprising the metal core coordinated with ligands comprising an oxygen-containing functional group; and
adding one or more metal oxide precursors to the solution comprising the metal core coordinated with the ligands comprising the oxygen-containing functional group to form the metal oxide coating.

### Advantageous Effects of Invention

According to the present invention, a nanoparticle population with a small average diameter and a high sintering temperature can be provided.

### DESCRIPTION OF DRAWINGS

FIG. 1 shows a schematic depiction of an example multi-layer ceramic capacitor.

FIG. 2 shows a bright mode transmission electron microscopy (TEM) image of a sample without any metal oxide coating prepared in comparative example 1.

FIG. 3 shows a dark mode transmission electron microscopy (TEM) image of a sample without any metal oxide coating prepared in comparative example 1.

FIG. 4 shows an energy dispersive X-ray analysis (EDX) image of a sample without any metal oxide coating prepared in comparative example 1 shown in FIG. 3.

FIG. 5 shows a schematic depiction of an example synthesis for forming nickel nanoparticles having a metal oxide coating with BaTiO₃.

FIG. 6 shows a flow diagram depicting an example method for forming a metal nanoparticle having a metal oxide coating.

FIG. 7 shows a graph depicting thermomechanical analysis (TMA) data for nickel nanoparticles nickel nanoparticles having a metal oxide coating with BaTiO₃.

FIG. 8 shows a graph depicting TMA data for nickel nanoparticles without any metal oxide coating prepared in comparative example 1.

FIG. 9 shows a bright mode transmission electron microscopy (TEM) image of the nickel nanoparticles having a metal oxide coating with BaTiO₃.

FIG. 10 shows a dark mode transmission electron microscopy (TEM) image of the nickel nanoparticles having a metal oxide coating with BaTiO₃.

FIG. 11 shows an energy dispersive X-ray analysis (EDX) image of the nickel nanoparticles having a metal oxide coating with BaTiO₃ of FIG. 10.

### DESCRIPTION OF EMBODIMENTS

Herein, examples are disclosed that relate to nanoparticle populations comprising metal oxide coatings. One example provides a nanoparticle population, each nanoparticle of the nanoparticle population comprising a metal core and a metal oxide coating at least partially covering a surface of the metal core, wherein an average diameter of the nanoparticles of the nanoparticle population is within a range of 2 nm-200 nm, and wherein the metal oxide coating comprises one or more selected from the group consisting of Ba, Ti, Zr, Hf, V, Nb, Ta, W and Mo.

Another example provides a method for synthesizing a nanoparticle comprising a metal core and a metal oxide coating. The method comprises obtaining a solution comprising the metal core coordinated with ligands comprising an oxygen-containing functional group, and adding one or more metal oxide precursors to the solution to form the metal oxide coating.

Another example provides a printable composition comprising a solvent and a population of nanoparticles dispersed in the solvent, wherein each nanoparticle of the population of nanoparticles comprises a metal core and a metal oxide coating at least partially covering the metal core, wherein an average diameter of the nanoparticles of the population of nanoparticles is within a range of 2 nm-200 nm, and wherein the metal oxide coating comprises one or more selected from the group consisting of Ba, Ti, Zr, Hf, V, Nb, Ta, W and Mo.

This Summary is provided in order to introduce in simplified form a selection of concepts that are further described in the Detailed Description. The Summary is not intended to identify key features or essential features of the claimed subject matter, nor is it intended to be used to limit the scope of the claimed subject matter.

According to the disclosure, examples are disclosed that relate to increasing a sintering temperature of a metal nanoparticle by coating the metal core with a metal oxide coating. As described in more detail below, the use of a metal oxide coating may increase a sintering temperature of a metal nanoparticle to a temperature suitably close to that of a dielectric material used with the metal nanoparticle in a MLCC, and thus enable the use of smaller metal nanoparticles in MLCCs, among other possible uses.

Techniques for coating metal particles with metal oxide coatings have been studied in the past.

For example, Patent Document 1 discloses a nickel powder with a composite oxide layer on a part of the surface. Patent Document 1 discloses a method in which nickel powder with composite oxide is obtained in a single operation by spraying a solution to form fine droplets, heating the droplets at a high temperature, and pyrolyzing the metal compound. However, since the spray pyrolysis method disclosed in Patent Document 1 utilizes droplets to obtain powder, it is difficult to obtain nanoparticle populations with oxide coatings on metal cores of 200 nm or less, as described above.

Patent document 2 also discloses a nickel fine powder surface-modified with barium titanate in a perovskite-type structure. In Patent document 2, nickel fine particles are brought into contact with a solution containing a soluble titanium compound and a soluble barium compound in a combination capable of producing barium titanate with a perovskite structure by heat treatment, and then heat treated at a temperature of 400 °C or higher to produce barium titanate with a perovskite structure from the precursor on the surface of the nickel fine particles. A method of coating the surface of nickel fine particles by generating barium titanate with a perovskite-type structure is disclosed. However, to obtain a nanoparticles population with oxide coatings on metal cores of 200 nm or less as described above by the method disclosed in Patent Document 2, heating at 400 °C or higher is essential, which may cause the metal core to start sintering before the oxide coating is formed, or oxidation or denaturation of the metal core surfaces may occur.

In other words, the need for metal cores with particle sizes smaller than before has made it difficult to obtain nanoparticle populations having metal cores of 200 nm or less with oxide coatings on by conventional methods.

Furthermore, forming metal cores using “bottom-up” methods that nucleate and then grow metal cores from solution, and then forming metal oxide coatings on metal nanoparticles may pose challenges. For example, ligands used in the metal core synthesis remain bound to the metal cores after synthesis, and may impede oxide coating growth. As a more specific example, nickel nanoparticles may be synthesized in an organic non-polar solvent such as octadecene using a nickel precursor such as nickel acetate and ligands such as trioctylphosphine and/or dodecylamine. The inventors have found that attempting to form BaTiO₃ coatings on such as-synthesized nickel nanoparticles may lead to metal oxide phases forming separately from the nickel nanoparticles.

After further studies, the inventors found that ligand exchange after synthesis of the metal core is effective. Thus, herein, examples are disclosed that relate to using a ligand exchange reaction to exchange at least some ligands bound to the as-synthesized metal cores for a ligand species comprising an oxygen-containing functional group. The oxygen-containing functional group may react with a metal oxide precursor, e.g. by a hydrolysis reaction, to form the metal oxide on the metal cores, rather than as an independent structure. The resulting metal oxide acts as a location where additional metal oxide precursor may react to grow a metal oxide coating. The disclosed metal oxide coating growth reactions may be performed at room temperature in some examples, and/or with relatively low applied heat in other examples. A variety of different metal oxide-coated metal cores may be formed in this manner. Examples include nickel nanoparticle populations comprising an average diameter within a range of 2 nm-200 nm, coated with an oxide comprising one or more selected from the group consisting of Ba, Ti, Zr, Hf, V, Nb, Ta, W and Mo. Here, the average diameter can be measured by calculating the area circular equivalent diameter (Heywood diameter) of 100 or more particles in a particle image observed by transmission electron microscopy (TEM). Other examples include palladium nanoparticles with such metal oxide coatings. In addition to nickel and palladium, metals such as silver, copper, gold, iron, and tin, or alloys of these metals can be used as the metal core if the application is not limited.

In some examples, a population of the disclosed nanoparticles may be used in a printable composition comprising a solvent in which the population of nanoparticles is dispersed. The printable composition may be used, for example, to print electrode layers for an MLCC during fabrication. As described below, the metal oxide coating may increase a sintering temperature of the metal nanoparticle to be suitably close to that of the dielectric material, thereby avoiding problems caused by sintering temperatures that are too far apart.

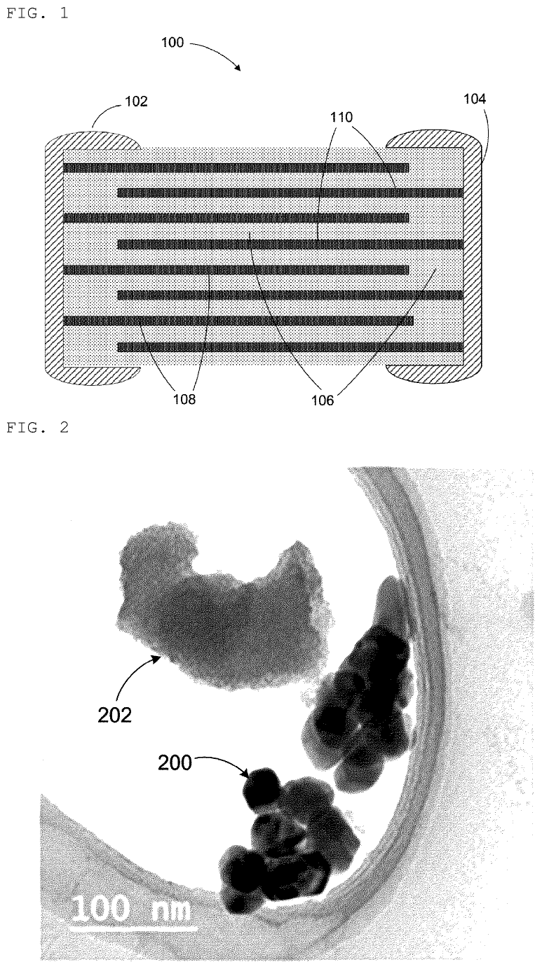

Before discussing these examples in more detail, FIG. 1 shows the structure of an example MLCC 100. MLCC 100 comprises a first set of connectors 102, a second set of connectors 104, and a dielectric material 106. The first set of connectors 102 are connected to electrodes 108. The second set of connectors 104 are connected to electrodes 110. As mentioned above, the electrodes may be formed from sintered metal nanoparticles, such as nickel and palladium nanoparticles. That is, the nanoparticle population in accordance with embodiments of the invention is located within one or more sintered layers of a MLCC.

The nanoparticle populations used to form electrodes 108 and 110 may have any suitable size. In some examples, the nanoparticle populations may comprise an average diameter within a range of 2 nm-200 nm. In more specific examples, the nanoparticle populations may comprise an average diameter within a range of 30-80 nm, which may facilitate the fabrication of thinner electrodes in an MLCC than conventional MLCCs.

However, as mentioned above, nanoparticles within this average diameter range may have a reduced sintering temperature compared to larger nanoparticles of the same metal. Thus, the nanoparticle populations of the present disclosure may comprise a metal oxide coating to provide a suitable sintering temperature to allow MLCC 100 to be sintered without unsuitable levels of metal nanoparticle diffusion into the dielectric material 106. Any suitable metal oxide coating may be used for the metal oxide coating. Examples include metal oxide coatings comprising one or more selected from the group consisting of Ba, Ti, Zr, Hf, V, Nb, Ta, W, and Mo. The metal oxide coating can include, for example, BaTiO₃, WO₃, Ta₂O₅, and others. Also, for example, the metal oxide coating can include ternary oxides. A specific example of a ternary oxide is BaTiO₃. In some examples, a same material may be used for a dielectric layer and for coating a metal nanoparticle core. In some more specific examples, the nanoparticle populations comprise BaTiO₃-coated nickel nanoparticles, and the dielectric material of MLCC also comprises BaTiO₃. For example, a sintering temperature of the nanoparticles of the nanoparticle population is higher than 750 °C.

As mentioned above, performing a wet chemical synthesis of a metal oxide in a solution of as-synthesized metal cores may result in the formation of independent oxide structures in solution, rather than the formation of metal oxide coatings on the metal cores.

Thus, the as-synthesized metal core is exchanged with a ligand comprising an oxygen-containing functional group for at least some of the ligands bound to the metal core to form a metal oxide coating on at least part of the metal core surface. Performing a ligand exchange reaction as described above to bind a ligand comprising an oxygen-containing functional group to metal cores may provide locations on at least part of the metal core surface at which oxide growth may occur.

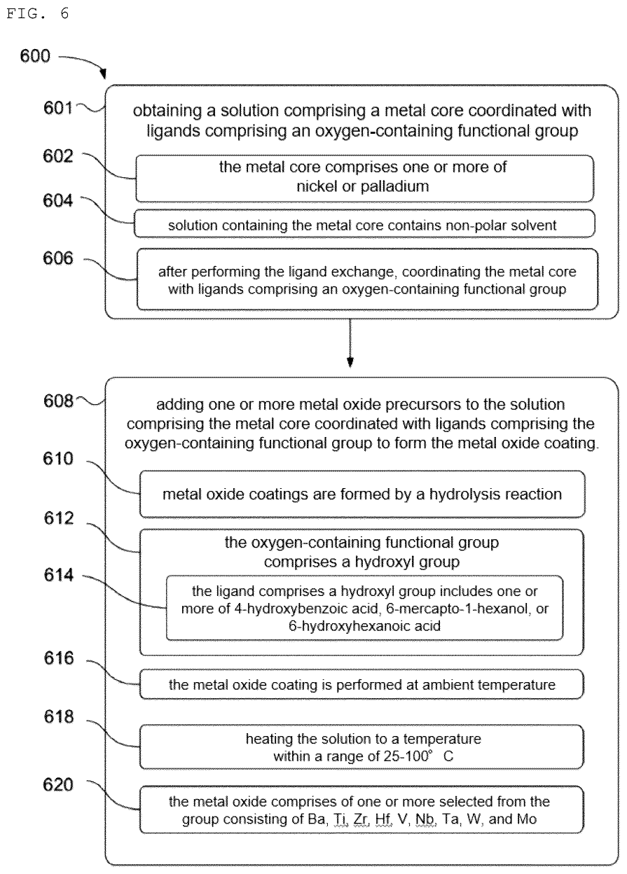

FIG. 5 shows an example synthesis 500 for forming a population of nickel nanoparticles coated with BaTiO₃. In other examples, synthesis 500 may be adapted to form other coated nanoparticle populations. Examples may include nickel nanoparticle populations and other nanoparticle populations containing metal cores coated with one or more of tungsten oxide and tantalum oxide.

First referring to 502 in FIG. 5, nickel metal cores 504 are synthesized. In the depicted example, the nickel metal cores 504 are synthesized at 502 by mixing nickel acetate in 1-octadecene, and then adding ligands to coordinate the nickel. Dodecylamine and trioctylphosphine are used as ligands in this example. Dodecylamine may also act as a reducing agent.

In other examples, any other suitable ligands and reducing agents may be used, including other amines and/or other phosphines. Likewise, other suitable solvents may be used in other examples. Suitable solvents may include other nonpolar solvents with boiling points above a metal core synthesis temperature.

After mixing the ligands with the nickel acetate, the mixture is degassed, heated to 220 °C for 2 hours to form the nickel metal cores 504, and then purified by liquid-liquid extraction. Nickel metal cores in the range of 2 nm-200 nm, for example, may be synthesized in this manner. Nanoparticle size may be tuned by varying the chemical ratios of ligands to metal core precursors such as nickel precursor and to each other, and/or by varying the ligand(s) and/or metal core precursors used.

An example liquid-liquid extraction process may utilize a two-solvent system comprising a polar solvent such as an ethanol and a non-polar solvent such as hexane. The nonpolar phase comprising the metal cores and excess acetate and/or other components is added to the polar phase, mixed to allow nickel acetate and other polar-soluble species to migrate between solvents at phase boundaries, and allowed to separate. The liquid-liquid extraction may be repeated as desired to obtain ligand-terminated nickel metal cores of a desired purity dispersed in the non polar solvent.

The resulting purified nickel metal cores 504 are bound by dodecylamine ligand 506 and trioctylphosphine 508 ligands, and are soluble in the non-polar solvent. It will be understood that the depiction of dodecylamine ligand 506 and trioctylphosphine 508 ligands compared to nickel metal core 504 in FIG. 5 is schematic, and that the relative sizes of the ligands are exaggerated for illustration. In practice, the nickel metal cores may be substantially surrounded by a concentration of ligand molecules in a concentration ratio based upon a ratio of the ligands used in the synthesis.

After growing the nickel metal cores 504, an oxide coating is formed on the nickel metal cores. As described above, it has been found that attempting to grow an oxide coating on the nickel metal cores without ligand exchange after formation of the nickel metal cores may result in the formation of independent oxide structures, rather than metal oxide coatings on the nickel metal cores. Thus, synthesis 500 as shown in FIG. 5 comprises performing a ligand exchange step 510 to at least partially exchange the dodecylamine 506 and trioctylphosphine 508 ligands with ligands comprising an oxygen containing functional group.

The depicted ligand exchange step 510 comprises adding 4-hydroxybenzoic acid, sonicating for 20 minutes, and stirring for 60 minutes at room temperature. This results in the exchange of at least some ligands on the nickel metal core surface with the 4-hydroxybenzoic acid. In other examples, any other suitable ligand exchange process may be used. FIG. 5 shows nickel metal core 504 after performing the ligand exchange step at 510. As depicted, the dodecylamine ligand 506 has been exchanged for a 4-hydroxybenzoic acid ligand 512. It will be understood that the trioctylphosphine ligands 508 additionally or alternatively may be exchanged for a 4-hydroxybenzoic acid ligand in some instances.

In other examples, any other suitable ligand comprising an oxygen-containing functional group may be used. Examples include ligands comprising linear or branched alkyl, alkenyl, or alkynyl chains with oxygen containing functional groups, such as 6-mercapto-1-hexanol and 6-hydroxyhexanoic acid, as well as ligands containing cyclic groups, and other aromatic ligands than 4-hydroxybenzoic acid. In yet other examples, ligands suitable for use in the present disclosure may comprise any other suitable oxygen-containing functional group, such as acetates, esters, ethers, ketones, and aldehydes.

The resulting solution is purified, for example, by using a liquid-liquid extraction process. An example liquid-liquid extraction process may utilize a two-solvent system comprising a polar solvent and a non-polar solvent. The presence of oxygen-containing functional group on at least part of the surface of the nickel metal cores enables the nickel metal cores to dissolve in a polar solvent. Any suitable solvents may be used. Example polar solvents may include water, alcohols (e.g. methanol, ethanol, propanols, etc.), acetonitrile, acetone, dimethylformamide, dimethylsulfoxide, and mixtures of two or more thereof. Example non-polar solvents may include hexane and other lower alkyls (e.g. pentane, heptane, octane, etc.), cyclic hydrocarbons (e.g. cyclopentane, cyclohexane, etc.), aromatics (e.g. benzene, toluene, xylene, pyridine, etc.), ethers (e.g. diethyl ether, ethyl propyl ether, etc.), acetates (e.g. ethyl acetate), halogenated solvents (e.g. chloroform, methylene chloride, etc.), and mixtures of two or more thereof. The polar phase and the non-polar phase are mixed to allow nickel metal cores to migrate between solvents at phase boundaries, allowed to separate and then decanted. The liquid-liquid extraction may be repeated as desired to obtain ligand-exchanged metal cores of a desired purity.

After performing the ligand exchange, precursors for the metal oxide coating are added to the solution containing the nickel metal cores, as shown in step 514 of FIG. 5. In the specific example of nickel nanoparticles to be coated with BaTiO₃, example precursors include compounds of divalent barium and tetravalent titanium. In some such examples, the compound may comprise organic anions. Such materials may allow the residual organic anionic material to be removed by oxidation during a MLCC sintering step.

More specific example precursors, as shown in FIG. 5, include barium acetate and titanium alkoxy compounds such as titanium isopropoxide. Other salts of these metal ions may be used in other examples, including inorganic salts where the anions are not detrimental to an intended use of the nickel nanoparticles (e.g. in an MLCC).

The oxygen-containing functional group on the ligand species bound to the nickel metal cores may undergo a hydrolysis reaction with the metal oxide precursors to form the metal oxide coating 516 on the nickel metal cores. The hydrolysis reaction in step 514 of FIG. 5 may be performed at any suitable temperature. Suitable temperature may vary depending on the reaction chemistry and the desired thickness of the metal oxide coating. For nickel metal cores, in some examples, the hydrolysis reaction in step 514 of FIG. 5 may be performed at room temperature. As a more specific example, the inventors have found that the reaction of barium acetate and titanium isopropoxide with the 4-hydroxybenzoic acid ligand occurs spontaneously at room temperature in solution. In other examples heating may be applied to raise the temperature of the solution. In some examples, the reaction solution may be heated to a temperature within a range of 25 to 100 °C. In one experiment, the efficacy of a metal oxide coating was improved compared to a room temperature-synthesized sample when the solution temperature was raised from room temperature to 50 °C, with all other factors remaining constant. In other examples, a reaction solution may be heated to a temperature outside of the above example range.

In the method disclosed in Patent Document 2, it was necessary to heat-treat the nickel fine particles at a temperature of 400 °C or higher to form barium titanate with a perovskite-type structure. In contrast, in the present invention, by exchanging at least some ligands bound to the as-synthesized metal core with ligand species containing an oxygen-containing functional group, the oxygen-containing functional group of the ligands act as reaction points with the metal oxide precursor. Therefore, even without heat treatment at a temperature of 400 °C or higher, oxide coatings can be formed on the metal cores, and thereby a nanoparticle population with oxide coatings on the metal cores can be obtained.

The metal oxide coating may be grown to any suitable thickness. Suitable thicknesses include thicknesses that achieve a desired increase in sintering temperature. For nickel nanoparticles, example metal oxide coating thicknesses include thicknesses within a range of 1 nm-30 nm. More preferably, the metal oxide coating thicknesses includes thickness within a range of 1 nm-10 nm. The metal oxide coating layer thickness may be controlled by varying metal oxide precursor concentrations, reaction times and/or solution temperature, among other possible reaction parameters. Such thicknesses may help to achieve a desired sintering temperature, while maintaining a sufficiently small nanoparticle size for MLCC use. The ratio of the thickness of the metal oxide coating to the diameter of said nanoparticles is not particularly limited, but a ratio within a range of 1:200-10:200 is preferred to obtain the aforementioned effect better.

In other examples, metal nanoparticles comprising a metal oxide coating may have sizes outside of this range. In other words, the method of forming metal oxide coatings on metal cores is not only effective for nano-scale size particles, but also for particles equal to or larger than nano-scale size particles, such as submicron size particles.

FIG. 6 shows a flow diagram depicting a method for forming a population of metal nanoparticles with a metal oxide coating on at least part of the surface of each metal cores of the population of metal nanoparticles. The term “population of metal nanoparticles” refers to a plurality of nanoparticles in a solution of nanoparticles, and may or may not encompass all of the nanoparticles in the solution in various examples.

Method 600 comprises, at 601, obtaining a solution comprising a metal core coordinated with ligands comprising an oxygen-containing functional group. In some examples, the metal core may comprise one or more of nickel or palladium, as indicated at 602. In other examples, the metal cores may comprise any other suitable metal. In some examples, the metal core solution may comprise a non-polar solvent as indicated at 604. In such examples, ligands may be bound to the metal cores that provide for solubility in the non-polar solvent. As such, obtaining the solution comprising the metal cores coordinated with ligands comprising an oxygen-containing functional group may comprise, at 606, performing a ligand exchange to coordinate at least some ligands comprising the oxygen-containing functional group to the metal core. Any suitable ligands comprising an oxygen-containing functional group may be used. In some examples, the oxygen containing functional group, at 612, comprises a hydroxyl group. Examples include, at 614, one or more of 4-hydroxybenzoic acid, 6-mercapto-1-hexanol, and 6-hydroxyhexanoic acid. In other examples, any other suitable ligand comprising an oxygen-containing functional group may be used. Examples of other oxygen-containing functional groups include acetates, esters, ethers, ketones and aldehydes. The ligands comprising the oxygen-containing functional groups may include linear or branched alkyl, alkenyl, alkynyl chains, cyclic groups, and/or aromatic groups in various examples.

Continuing, method 600 further comprises, at 608, adding one or more metal oxide precursors to the solution 601 comprising the metal core coordinated with ligands comprising the oxygen-containing functional group to form the metal oxide coating. In some examples, the metal oxide coating may be formed by a hydrolysis reaction, as indicated at 610. The functional groups of the ligand comprising an oxygen-containing functional group coordinated to the metal core may serve as locations for the hydrolysis reactions. The oxygen-containing functional group may react with the metal oxide precursors to form the metal oxide coating on at least part of the surface of the metal cores. In some examples, the metal oxide coating may be formed at ambient temperature as the hydrolysis reaction may proceed under ambient conditions as indicated at 616. In other examples, the metal oxide coating may be formed, at 618, by heating the solution. Examples include heating the solution to a temperature within a range of 25-100 °C as indicated in 618. In other examples, the solution may be heated to any suitable temperature that results in the formation of the metal oxide coating. Any suitable metal oxide precursor(s) may be used. In some examples, as described above, metal salts comprising organic anions may be used. In other examples, metal salts comprising inorganic anions may be used where suitable.

Any suitable metal oxide coating may be formed. In some examples, the metal oxide, at 620, may comprise of one or more selected from the group consisting of Ba, Ti, Zr, Hf, V, Nb, Ta, W, and Mo. A metal oxide coating that is formed may comprise a same material as used in a dielectric material of a MLCC. For example, a metal nanoparticle intended for use in a MLCC comprising a BaTiO₃ dielectric may be coated with a BaTiO₃ coating. Other more specific examples include metal nanoparticles coated with one or more of tungsten oxide and tantalum oxide.

As mentioned earlier, the use of a metal oxide coating may increase a sintering temperature of a metal nanoparticle to a temperature suitably closer to that of a dielectric material used with the metal nanoparticle compared to a metal nanoparticle not coated with metal oxide of a same metal composition and size. Examples include using nickel nanoparticles with BaTi₃ as the dielectric material. In some examples, the metal oxide coating on the metal cores may be of the same material as the dielectric material. More specifically, BaTiO₃ coated nickel nanoparticles may be used with BaTiO₃ as the dielectric material.

As mentioned above, a population of the disclosed example nanoparticles comprising metal cores and oxide coatings may be used in a printable composition. Such a printable composition may be used, for example, to print electrodes for a MLCC during MLCC fabrication. The printable composition may comprise a solvent, a population of nanoparticles dispersed in the solvent, and optionally one or more additives.

Example nanoparticles include the nanoparticles having metal oxide coating described above. Any suitable solvent that disperses the above mentioned nanoparticles may be used. Example solvents that may be suitable for such a printable composition may include water, a nitrile, an aromatic alcohol, an alkene, an alcohol, a ketone, an aldehyde, an ether, an ester, a hydrocarbon, and a mixture of two or more thereof. A solvent or solvent mixture choice may depend upon a printing method to be used. For example, with regard to inkjet printing, a solvent or solvent mixture choice may depend upon whether thermal inkjet or piezoelectric inkjet printing is used.

In some examples, a printable composition may comprise one or more additives. Example additives may include one or more of a surfactant(s), a biocide(s) a rheology modifier(s), and a polymer(s). In some examples, one or more polymers may be introduced in suitable amounts to obtain a desired adhesion of the ink to a substrate. Furthermore, in some examples, one or more rheology modifiers such as a viscosity adjuster may be added to adjust a viscosity of an ink to a value suitable for a desired end use (e.g. a desired printing technique). In some such examples, a viscosity of the printable composition may be adjusted to a value of between 2 and 20 centipoise (cP).

Nanoparticle population, printable composition, and method for producing nanoparticles in accordance with one embodiment of the present invention include the following configurations.
(1) A nanoparticle population, in which each nanoparticle of the nanoparticle population comprises a metal core and a metal oxide coating at least partially covering the metal core, wherein an average diameter of the each nanoparticle is within a range of 2 nm-200 nm, and wherein the metal oxide coating comprises one or more selected from the group consisting of Ba, Ti, Zr, Hf, V, Nb, Ta, W and Mo.
(2) The nanoparticle population according to (1) above, wherein the metal core comprises nickel or palladium.
(3) The nanoparticle population according to (1) or (2) above, wherein the metal oxide coating comprises one or more selected from the group consisting of Ba, Ti, Ta, and W.
(4) The nanoparticle population according to any one of (1) to (3) above, wherein the metal oxide coating comprises a ternary oxide.
(5) The nanoparticle population according to any one of (1) to (4) above, wherein the metal oxide coating comprises BaTiO₃.
(6) The nanoparticle population according to any one of (1) to above, wherein the metal oxide coating comprises a thickness within a range of 1 nm to 30 nm.
(7) The nanoparticle population according to any one of (1) to (6) above, wherein a ratio of a thickness of the metal oxide coating to the nanoparticle diameter has a value within a range of 1:200 to 10:200.
(8) The nanoparticle population according to any one of (1) to (7) above, wherein a sintering temperature of the nanoparticles of the nanoparticle population is higher than 750 °C
(9) The nanoparticle population according to any one of (1) to (8) above, wherein the average diameter of nanoparticles of the nanoparticle population is within a range of 10 nm to 50 nm.
(10) The nanoparticle population according to any one of (1) to (9) above, wherein the nanoparticle population is located within one or more sintered layers of a multilayer ceramic capacitor.
(11) The nanoparticle population according to any one of (1) to (10) above, wherein the nanoparticles of the nanoparticle population are coordinated with ligands comprising an oxygen-containing functional group.
(12) The nanoparticle population according to (11) above, wherein the oxygen-containing functional group comprises one or more of a carboxyl group and a hydroxyl group.
(13) A printable composition comprising a solvent and the nanoparticle population according to any one of (1) to (12) above dispersed in the solvent.
(14) a method for synthesizing a nanoparticle comprising a metal core and a metal oxide coating at least partially covering a surface of the metal core, the method comprising:
obtaining a solution comprising the metal core coordinated with ligands comprising an oxygen-containing functional group; and
adding one or more metal oxide precursors to the solution comprising the metal core coordinated with the ligands comprising the oxygen-containing functional group to form the metal oxide coating.
(15) The method for synthesizing the nanoparticle according to (14) above, wherein the metal oxide coating is formed by a hydrolysis reaction.
(16) The method for synthesizing the nanoparticle according to (14) or (15) above wherein the oxygen-containing functional group comprises a hydroxyl group.
(17) The method for synthesizing the nanoparticle according to any one of (14) to (16) above, wherein the ligand comprises one or more of 4-hydroxybenzoic acid or 6-marcapto-1-hexanol and 6-hydroxyhexanoic acid.
(18) The method for synthesizing the nanoparticle according to any one of (14) to (17) above, wherein the hydrolysis reaction is performed at ambient temperature.
(19) The method of for synthesizing the nanoparticle according to any one of (14) to (18) above, wherein the hydrolysis reaction is performed while the solution is heated to temperature within a range of 25-100 °C.
(20) The method of for synthesizing the nanoparticle according to any one of (14) to (19) above, wherein the metal core comprises one or more of nickel and palladium.
(21) The method of for synthesizing the nanoparticle according to any one of (14) to (20) above, wherein the metal oxide comprises one or more of Ba, Ti, Zr, Hf, V, Nb, Ta, W and Mo.
(22) A composition comprising a solvent and a nanoparticle population dispersed in the solvent,
wherein the composition is printable,
   wherein each nanoparticle of the nanoparticle population comprises a metal core and a metal oxide coating at least partially covering the metal core,
   wherein an average diameter of the nanoparticle is within a range of 2 nm-200 nm, and
   wherein the metal oxide coating comprises one or more selected from the group consisting of Ba, Ti, Zr, Hf, V, Nb, Ta, W and Mo.
(23) The composition according to (22) above, wherein said solvent contains one or more of the group consisting of water, nitriles, aromatic alcohols, alkenes, alcohols, ketones, aldehydes, ethers, esters, and hydrocarbons.
(24) The composition according to (22) above, wherein said metal core includes one or more of nickel and palladium and said metal oxide coating includes one or more selected from the group consisting of BaTiO₃, WO₃, and Ta₂O₅.
(25) The composition according to (22) above, wherein the sintering temperature of the nanoparticles is higher than 750 °C.
(26) The composition according to (22) above, wherein said composition includes any one or more selected from the group consisting of surfactants, biocides, rheology modifiers, and polymers.

It will be understood that the configurations and methods described herein are provided by way of example, and that these examples are not to be considered in a limiting sense because numerous variations, extensions, and omissions are also envisaged. Any of the various acts of an above method may be performed in the sequence illustrated, in other sequences, in parallel, or omitted. The subject matter of the present disclosure includes all novel and non-obvious combinations and sub-combinations of the various configurations, methods, properties, and other features disclosed herein, as well as any and all equivalents thereof.

### EXAMPLE

### Example 1

### (Nickel Metal Core Synthesis)

Nickel acetate was mixed in 1-octadecene, then dodecylamine and trioctylphosphine were added as ligands to coordinate the nickel, and after degassing, the reaction was carried out at 220 °C for 2 hours and cooled. Liquid-liquid extraction was then performed by adding a mixture of solvents containing the polar solvent ethanol and the nonpolar solvent hexane to the liquid after nickel metal core synthesis and mixing to allow nickel acetate and other polar-soluble species to migrate between solvents at phase boundaries. After the liquid-liquid extraction, the nickel metal core was redispersed in hexane to obtain a nickel metal core dispersion liquid.

### (Ligand Exchange)

6-hydroxyhexanoic acid was added to the nickel metal core dispersion liquid obtained by dispersing the nickel metal core in hexane and sonicated for 20 minutes. The oxygen in the hydroxy group of the ligand provides oxygen for metal oxide coating formation.

### (Metal Oxide Coating)

The nickel metal cores that were subjected to the ligand exchanges were suspended in ethanol or other alcohol. Synthesis of the metal oxide coating was performed by dissolving barium acetate and titanium isopropoxide in the nickel metal core suspension liquid and retaining it at 50 °C for 20 minutes. This resulted in a nickel nanoparticle population with BaTiO₃ as the metal oxide coating.

### Example 2

The nanoparticle population was obtained in the same manner as in Example 1, except that 4-hydroxybenzoic acid was used as the ligand comprising an oxygen-containing functional group during the ligand exchange and the reaction of forming the metal oxide coating was performed by stirring at room temperature for 60 minutes.

### Example 3

The nanoparticle population was obtained as in Example 1, except that 6-mercapto-1-hexanol was used as the ligand comprising an oxygen-containing functional group during ligand exchange.

### Example 4

The nanoparticle population was produced as in Example 1, except that tungsten chloride (WCl₆) was added instead of barium acetate and titanium isopropoxide during the synthesis of the metal oxide coating.

This resulted in a nickel nanoparticle population having WO₃ as the metal oxide coating.

### Example 5

The nanoparticle population was produced as in Example 1, except that tantalum isopropoxide was added instead of barium acetate and titanium isopropoxide during the synthesis of the metal oxide coating.

This resulted in a nickel nanoparticle population with Ta₂O₅ as the metal oxide coating.

### Example 6

The nanoparticle population was produced in the same manner as in Example 1, except that tantalum butoxide was added instead of barium acetate and titanium isopropoxide during the synthesis of the metal oxide coating.

This resulted in a nickel nanoparticle population with Ta₂O₅ as the metal oxide coating.

### Comparative Example 1

After synthesizing the nickel metal core as in Example 1, the core was suspended in ethanol or other alcohol without ligand exchange, barium acetate and titanium isopropoxide were dissolved in the suspension liquid, and the suspension liquid was maintained at 50 °C for 20 minutes.

### (Characterization)

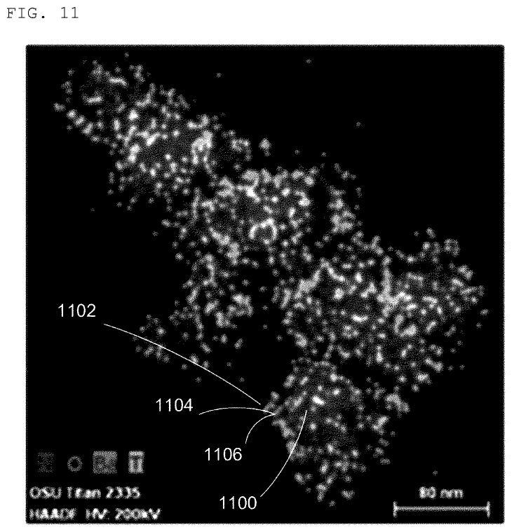

The nickel nanoparticle population produced in Example 1 were analyzed by bright mode TEM, dark mode TEM and EDX. Images from these analyses are shown respectively in FIGS. 9-11. The bright mode TEM image in FIG. 9 shows a sample nickel nanoparticle 902 with a metal oxide coating 904. The dark mode TEM image in FIG. 10 shows a faint image of the metal oxide coating 1000 around a sample nickel nanoparticle 1002. The TEM images show the presence of a metal oxide coating around d the nickel nanoparticles. The composition of the metal oxide coating was analyzed by EDX and the data is shown in FIG. 11.

In FIG. 11, the predominant presence of nickel and the absence of oxygen or other element suggests that the metal core 1100 is composed of nickel. The surface of nickel shows the presence of Ti 1102, Ba 1104 and O 1106 and suggests that the metal oxide coating may comprise BaTiO₃.

The average diameter was measured as described above based on the particle images observed by TEM.

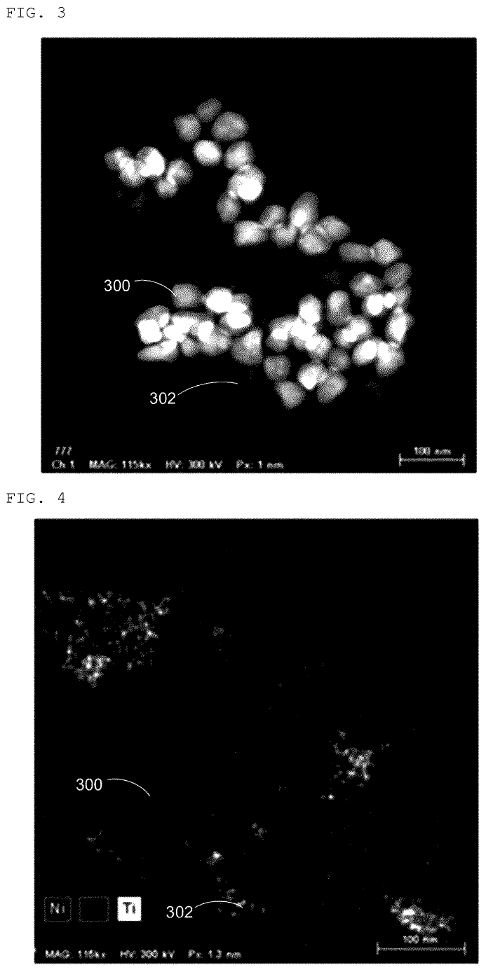

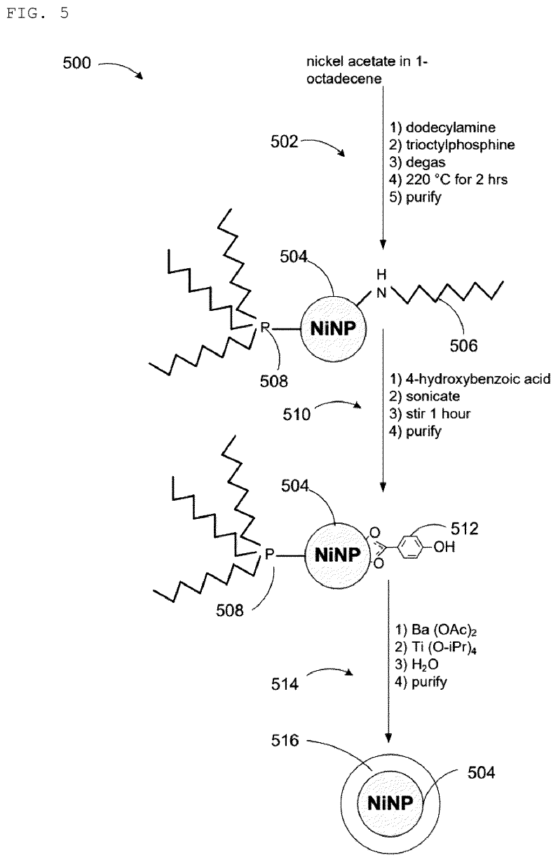

On the other hand, FIGS. 2-4 respectively illustrate bright mode TEM, dark mode TEM, and energy dispersive X-ray (EDX) analysis images for the sample obtained in comparative example 1. As can be seen in FIGS. 2-4, an oxide phase was formed separately from the nickel metal cores. More particularly, the bright mode TEM image of FIG. 2 shows nickel metal cores at 200, and a separate oxide phase at 202. Likewise, the dark mode TEM image of FIG. 3 shows nickel metal cores at 300, and a faintly visible separate oxide phase, for example at 302. The EDX image of FIG. 4, which corresponds to the TEM image of FIG. 3, more clearly illustrates the nickel metal cores 300 and separate oxide phase 302.

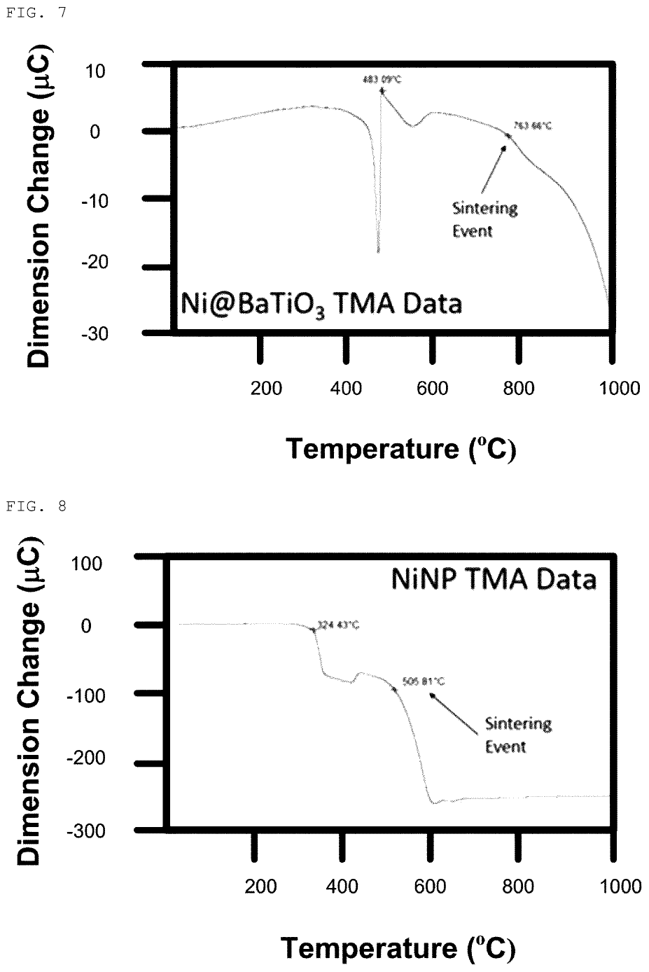

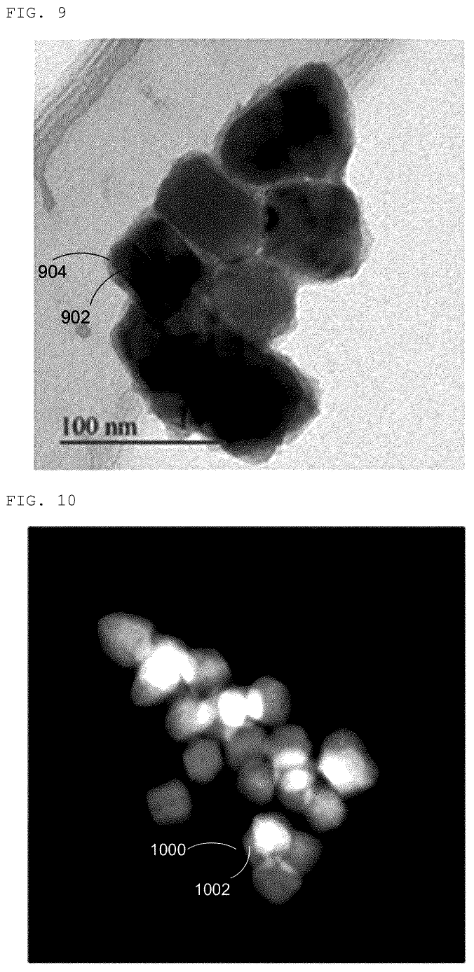

Example nickel nanoparticles coated with BaTiO₃ were analyzed using TMA, the results of which are shown in FIG. 7. The data in FIG. 7 suggest that the metal oxide coated nickel nanoparticles may sinter at 763.44 °C or more. In comparison, the sample in comparative example 1 which is not coated with metal oxide, with size similar to the uncoated nickel nanoparticles discussed in FIG. 7, may sinter at 505.81 °C or more as shown in FIG. 8. This suggests that BaTiO₃ coatings may lead to a substantial increase in the sintering temperature of nickel nanoparticles.

Thus, metal oxide coatings formed on metal nanoparticles through a ligand exchange process using the wet chemistry approach may result in a desired increase in the sintering temperature of the metal nanoparticles.

The evaluation results of the samples prepared in Examples 1-6 and Comparative Example 1 are summarized in Table 1 below.

TABLE 1

| | | | | Thickness | Starting |
|---|---|---|---|---|---|
| | | | | of Metal | Temperature |
| | | Metal | Average | Oxide | of |
| | Metal | Oxide | Diameter | Coating | Sintering |
| | Core | Coating | (nm) | (nm) | (°C) |
| Ex. 1 | Ni | BaTiO₃ | 63 | 2.5 | 763.4 |
| Ex. 2 | Ni | BaTiO₃ | 62 | 3.2 | 780.8 |
| Ex. 3 | Ni | BaTiO₃ | 62 | 2.3 | 773.4 |
| Ex. 4 | Ni | WO₃ | 60 | 2.6 | 756.8 |
| Ex. 5 | Ni | Ta₂O₅ | 63 | 2.8 | 753.4 |
| Ex. 6 | Ni | Ta₂O₅ | 64 | 3.5 | 770.8 |
| Comp Ex. 1 | Ni | — | 60 | — | 505.8 |

### REFERENCE CHARACTERS LIST

100 multi-layer ceramic capacitor
102 first set of connectors
104 second set of connectors
106 dielectric material
108 electrode
110 electrode
200 nickel metal core
202 separate oxide phase
300 nickel metal core
302 separate oxide phase
902 nickel nanoparticles
904 metal oxide coating
1000 metal oxide coating
1002 nickel nanoparticles
1100 metal core
1102 Ti
1104 Ba
1106 O

1. A nanoparticle population, each nanoparticle of the nanoparticle population comprising:
a metal core; and
a metal oxide coating at least partially covering a surface of the metal core,
wherein an average diameter of the each nanoparticle is within a range of 2 nm-200 nm, and wherein the metal oxide coating comprises one or more selected from the group consisting of Ba, Ti, Zr, Hf, V, Nb, Ta, W and Mo.

2. The nanoparticle population according to claim 1, wherein the metal core comprises nickel or palladium.

3. The nanoparticle population according to claim 1, wherein the metal oxide coating comprises one or more selected from the group consisting of Ba, Ti, Ta, and W.

4. The nanoparticle population according to claim 1, wherein the metal oxide coating comprises a ternary oxide.

5. (canceled)

6. The nanoparticle population according to claim 1, wherein the metal oxide coating comprises a thickness within a range of 1 nm to 30 nm.

7. The nanoparticle population according to claim 1, wherein a ratio of a thickness of the metal oxide coating to the nanoparticle diameter has a value within a range of 1:200 to 10:200.

8. The nanoparticle population according to claim 1, wherein a sintering temperature of the nanoparticles of the nanoparticle population is higher than 750 °C.

9. The nanoparticle population according to claim 1, wherein the average diameter of nanoparticles of the nanoparticle population is within a range of 10 nm to 50 nm.

10. The nanoparticle population according to claim 1, wherein the nanoparticle population is located within one or more sintered layers of a multilayer ceramic capacitor.

11. The nanoparticle population according to claim 1, wherein the nanoparticles of the nanoparticle population are coordinated with ligands comprising an oxygen-containing functional group.

12. The nanoparticle population according to claim 11, wherein the oxygen-containing functional group comprises one or more of a carboxyl group and a hydroxyl group.

13. A printable composition comprising a solvent and the nanoparticle population according to claim 1 dispersed in the solvent.

14. A method for synthesizing a nanoparticle comprising a metal core and a metal oxide coating at least partially covering a surface of the metal core, the method comprising:
obtaining a solution comprising the metal core coordinated with ligands comprising an oxygen-containing functional group; and
adding one or more metal oxide precursors to the solution comprising the metal core coordinated with the ligands comprising the oxygen-containing functional group to form the metal oxide coating.

15. The method for synthesizing the nanoparticle according to claim 14, wherein the metal oxide coating is formed by a hydrolysis reaction.

16. The method for synthesizing the nanoparticle according to claim 14 wherein the oxygen-containing functional group comprises a hydroxyl group.

17. The method for synthesizing the nanoparticle according to claim 14, wherein the ligand comprises one or more of 4-hydroxybenzoic acid or 6-marcapto-1-hexanol and 6-hydroxyhexanoic acid.

18. The method for synthesizing the nanoparticle according to claim 14, wherein the hydrolysis reaction is performed at ambient temperature.

19. The method of for synthesizing the nanoparticle according to claim 14, wherein the hydrolysis reaction is performed while the solution is heated to a temperature within a range of 25-100 °C.

20. The method of for synthesizing the nanoparticle according to claim 14, wherein the metal core comprises one or more of nickel and palladium.

21. The method of for synthesizing the nanoparticle according to claim 14, wherein the metal oxide comprises one or more of Ba, Ti, Zr, Hf, V, Nb, Ta, W and Mo.
